(19) United States
(12) Patent Application Publication
(10) Pub. No.: US 2006/0276957 A1
(43) Pub. Date: Dec. 7, 2006

(54) Visual aircraft spacing tool

(76) Inventors: Kevin Burnett, Ottawa (CA); Gregg Scully, Surrey (CA); Don Davis, Calgary (CA); James Krause, Beaumont (CA); Ken Cooper, Kelowna (CA); Ralph Musclow, Ottawa (CA); Patrick Beasley, Kanata (CA)

Correspondence Address: Gowling, Lafleur, Henderson, LLP, 2600-160 Elgin Street, Ottawa, ON, K1P 1C3, CA

(21) Appl. No.: 11/292,696

(22) Filed: Dec. 1, 2005

Related U.S. Application Data
(60) Provisional application No. 60/651,654, filed on Feb. 11, 2005.

(30) Foreign Application Priority Data
Dec. 3, 2004 (CA) 2,489,122

(51) Int. Cl. G01C 23/00; G06G 7/70

(52) U.S. Cl. 701/120; 701/3

(57) ABSTRACT

An air traffic display aid and method that uses parameters for defining a heading for an alpha approach and a beta approach. These can be intersecting or converging runways, dependent or independent parallel runways or airways in en-route configurations. A target reference point is determined in dependence upon the alpha and beta approaches. And an image reference point is determined in dependence upon at least one of the target reference point, a difference between the headings, a characteristic of the beta approach and an offset. Single target mirror ghosting, in-trail ghosting on demand, associated configurations and user selectable resynchronization spacing is also supported.

This application claims priority under 35 U.S.C. § 119(e) to co-pending U.S. Provisional Patent Application No. 60/651,654, which was filed on Feb. 11, 2005; this application also claims priority under 35 U.S.C. §119 on the basis of Canadian Patent Application No. 2,489,122 dated Dec. 3, 2004. This present application hereby claims the benefit of these earlier filing dates under 35 U.S.C. §120.

### FIELD OF THE INVENTION

The present invention relates to air traffic display aids and is particularly concerned with tools for visual aircraft spacing.

### BACKGROUND OF THE INVENTION

Efficient use of airport runway systems is dependent upon air traffic controllers' ability to space aircraft for landing or take off as closely as allowed by air traffic regulations. This task is particularly challenging when multiple runways are involved, particularly in the case of converging runways or parallel runways that are close enough together for each to be dependent on the traffic on the other.

A solution to the converging runways scenario was taught by Anand D. Mundra, in U.S. Pat. No. 4,890,232, issued on Dec. 26, 1989. The patent deals with the scenario of a first approach and a second approach intersecting the first. Mundra proposed displaying, along a line parallel to the second approach, a mirror image of aircraft on the first approach. The air traffic controller could then stagger the second approach aircraft by positioning them midway between the mirror images, thereby effectively spacing all approaching aircraft. As this was an early attempt to provide such an aid to air traffic controllers there were opportunities for improvement.

A paper “Converging Runway Display Aid As a Means to Increase Airport Capacity” presented in 2000, by Kevin Burnett, Patrick Beasley and Dr. Anand Mundra, discussed enhancements to Dr. Mundra's 1989 patent. The converging runway display aid (CRDA) described in the paper provides several different modes of displaying ghost images. As shown in FIG. 1, CDRA requires specification of an alpha approach 10 and a beta approach 12. Aircraft 14 have ghosts 16 projected from the alpha approach 10 to the beta approach 12. CRDA has two modes of display, so called “stagger mode” and “tie mode”. The stagger mode is the same mode as taught in the patent, i.e. where the air traffic controller staggers the aircraft by having them move to a position between the ghost images. The tie mode is illustrated in FIG. 1. With the tie mode CDRA provides a tie mode spacing 18 between where the ghost image would appear if just mirrored and the actual placement of the ghost image. Hence the ghosts appear at the desired position for the beta approach aircraft. This visually simplifies the task of positioning the aircraft with the desired spacing. The paper provides further enhancements to the basic concepts of CDRA.

In FIG. 2 a concept of in-trail ghosting is illustrated. With in-trail ghosting, an in-trail ghost 20 is created from a real aircraft 14 on the alpha approach 10 to aid in the placement of another aircraft 141 on that approach.

At times, there may be gaps in the aircraft approaching on the alpha (primary) approach 10, such that it becomes necessary to resynchronize with the beta runway. A further enhancement illustrated in FIG. 3 provides for ghosting of aircraft 16 from the beta approach 12 back to the alpha approach 10 in order to aid in the “resynching” of air traffic. The ghost 24 is placed using a selectable spacing 26 back from the mirror position of aircraft 16.

The paper also introduces the concept of smart ghosting as illustrated in FIG. 4. With smart ghosting, an aircraft's weight category is taken into account, by providing a longer tie mode 28 and in trail 34 spacing for heavy aircraft 30 to generating tie mode 32 and in trail 36 ghosts allow for wake turbulence created by such aircraft.

The paper also mentions that a CDRA system has been operational at Calgary Alberta airport since May 2000.

Despite the disclosure of CRDA concepts and implementation at a single airport, many issues remain with regard to development of an air traffic control display aid adaptable to any geometry and configuration.

### SUMMARY OF THE INVENTION

An object of the present invention is to provide an improved visual aircraft spacing tool.

In accordance with an aspect of the present invention there is provided a method of visual aircraft spacing comprising the steps of: determining heading for an alpha approach; determining a heading for a beta approach; defining a target reference point in dependence upon the alpha and beta approaches; and determining an image reference point in dependence upon at least one of the target reference point, a difference between the headings, a characteristic of the beta approach and an offset.

In accordance with another aspect of the present invention there is provided an visual aircraft spacing tool comprising: a parameter for defining a heading for an alpha approach; a parameter for defining a heading for a beta approach; a module for defining a target reference point in dependence upon the alpha and beta approaches; and a module for determining an image reference point in dependence upon at least one of the target reference point, a difference between the headings, a characteristic of the beta approach and an offset.

### BRIEF DESCRIPTION OF THE DRAWINGS

The present invention will be further understood from the following detailed description with reference to the drawings in which:

FIG. 1 graphically illustrates a first mode of a known converging runway display aid (CRDA);

FIG. 2 graphically illustrates a second mode of the known CRDA of FIG. 1;

FIG. 3 graphically illustrates a third mode of the known CRDA of FIG. 1;

FIG. 4 graphically illustrates a fourth mode of the known CRDA of FIG. 1;

FIG. 5 illustrates in a functional block diagram an visual aircraft spacing tool (VAST) in accordance with an embodiment of the present invention;

FIG. 6 illustrates in a state diagram for a beta approach ghosting qualification region in accordance with an embodiment of the present invention;

FIGS. 7a, b, c and d graphically illustrate runway configuration with reference points applied in accordance with an embodiment of the present invention;

FIG. 8 graphically illustrates a plurality of reference points in accordance with an embodiment of the present invention for an intersecting runway example;

FIG. 9a, b and c graphically illustrates tie mode ghosting for the example of FIG. 8;

FIGS. 10a and 10b graphically illustrate in trail ghosting for the example of FIG. 8;

FIGS. 11a, 11b, and 11c graphically illustrate resynchronization for the example of FIG. 8;

FIGS. 12a and 12b graphically illustrate smart in trail ghosting by a known method and in accordance with an embodiment of the present invention;

FIG. 13 graphically illustrates track sequence lists in accordance with an embodiment of the present invention;

FIGS. 14 and 15 graphically illustrates a high level of detailed data flow of track update process;

FIG. 16 graphically illustrates two overlapping qualification regions in accordance with an embodiment of the present invention;

FIGS. 17a and 17b graphically illustrate direct route and indirect route examples of en-route VAST configurations in accordance with an embodiment of the present invention;

FIGS. 18a and 18b illustrate data flow for activation and deactivation, respectively, of en-route VAST in accordance with an embodiment of the present invention;

FIG. 19 illustrates data flow for a track update in en-route VAST;

FIG. 20 graphically illustrates an example of a mirror ghosting projection in accordance with an embodiment of the present invention; and

FIG. 21 graphically illustrates an example of mirror ghosting on a single track in accordance with an embodiment of the present invention.

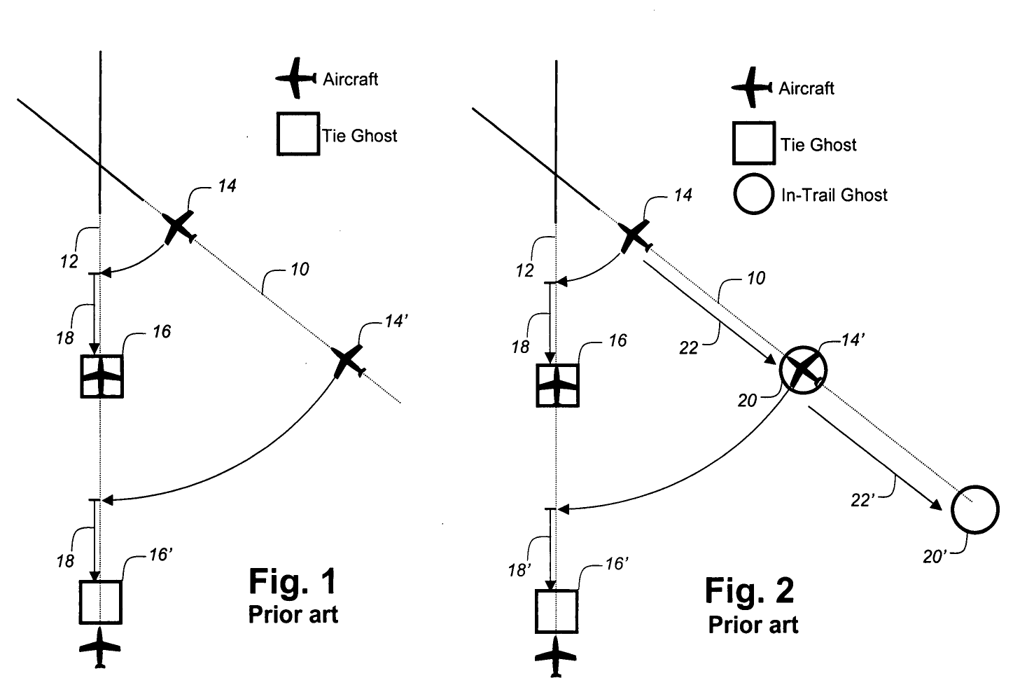

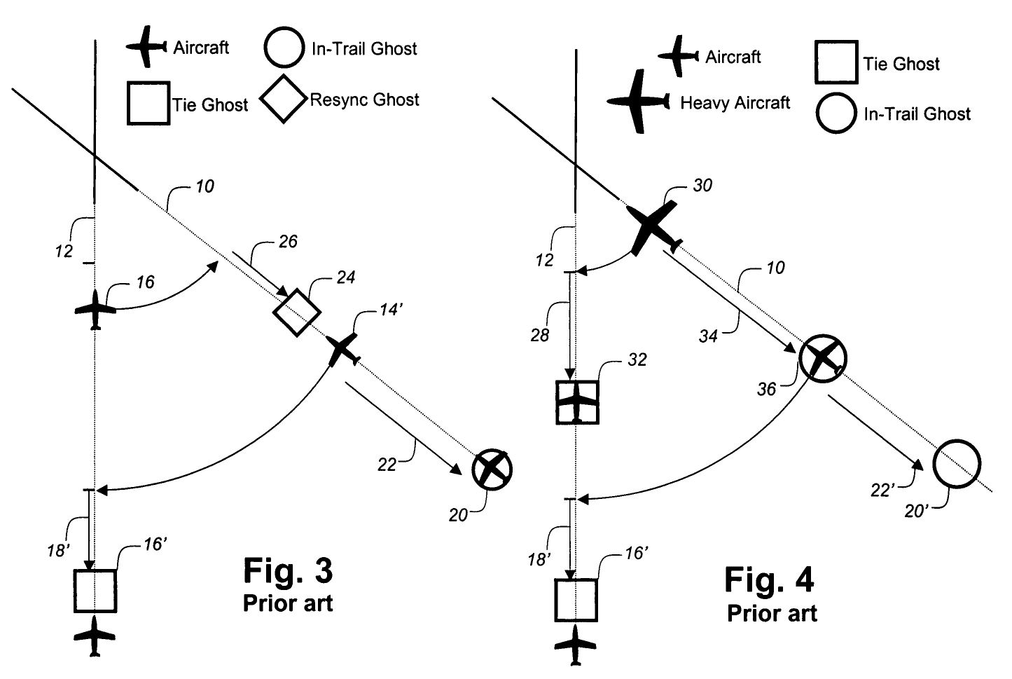

### DETAILED DESCRIPTION OF THE PREFERRED EMBODIMENT

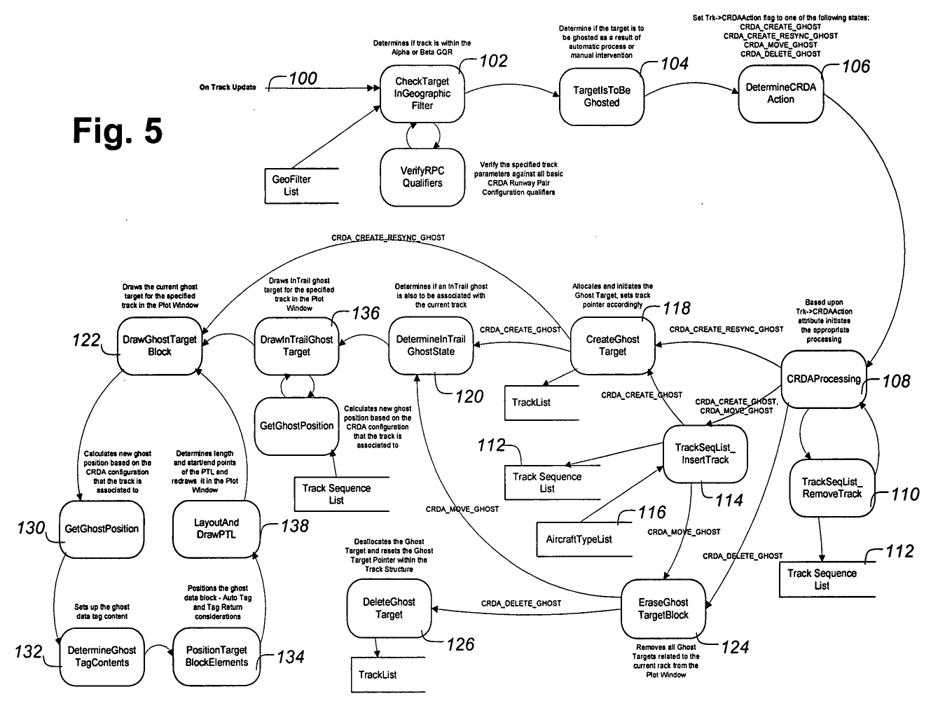

Referring to FIG. 5, there is illustrated in a functional block diagram main VAST data flow in accordance with an embodiment of the present invention.

A main point of entry for the VAST (Visual Aircraft Spacing Tool) processing is initiated with a track update 100. A track update processing PlotUpdate( ) routine performs three actions with respect to VAST:
1. Handles the drawing of any non-configuration based ghosting in trail targets.
2. Handles the recording of any trail dots required for VAST rendered targets.
3. Triggers the core VAST processing of each track for which an update is received.

This is done implicitly through the CheckTargetInGeographicFilters( ) call 102.

The primary purpose of the check Target in Geographic Filter function with respect to VAST is simply to mark the track's attributes that indicate what VAST configuration, if any, the track is subject to processing by (Trk->CRDARPC) on the current update. Although the software allows for any number of active VAST configurations, an individual track can only be processed by a single VAST configuration at any one time.

The following is a high level overview of the VAST functionality handled by the CheckTargetInGeographicFilters( ) 102 routine:

```
For each active geographical filter
  If the track is within the physical boundaries of
the region
    If the track is within a link
      mark the track as if it is within the
    main region¹
    End if the track is in a linked region
    Switch(type of filter)
    Case Alpha Ghosting Qualification Region:
      If CRDA is not active²
        Stop processing this filter
      End if CRDA is not active
      If the track is not already associated
to an alpha GQR³
        Set the Trk->CRDARPC attribute to
this configuration name⁴
        End if the track is not already
associated to an alpha GQR
      If a log entry is required⁵ and
        the track is correlated and
        matches all qualifiers
        Make the log entry
    End log entry required
    Case Beta Ghosting Qualification Region:
      If CRDA is not active
        Stop processing this filter
      End if CRDA is not active
      If the track is not already associated
to a beta GQR⁶
        Set the Trk->CRDABetaGQR
attribute to this filter name⁷
      End if the track is not already
associated to a beta GQR
      If the track is correlated
        If the track meets all of the
region qualifiers
          Mark the region as active⁸
        End if the track meets the
qualifiers
      End if the track is correlated
    End Switch on filter type
  End if the track is within the physical boundaries
of the region
End for each active geographical filter
Target IsToBeGhosted( )
DetermineCRDAAction( )
CRDAProcessing( )
```

As seen in the pseudo code illustrated above, the CheckTargetInGeographicFilters( ) terminates by calling TargetIsToBeGhosted( ) 104, DetermineCRDAAction( ) 106 and CRDAProcessing( ) 108 from the entry point into the main VAST logic.

The main purpose of the TargetIsToBeGhosted( ) function 104 is to determine if the current track requires any type of ghosting on this update. The track requires ghosting if one of the following conditions is met:
The user has manually forced on a ghost for this aircraft (includes manual request of a Resynchronization ghost), or
The track is correlated, within an alpha GQR, and matches the qualifications of that region.

As the following pseudo code illustrates, this is not quite as straightforward as it sounds:

```
If the track is within a total target filter
  Track is not to be ghosted - return FALSE
End if the track is within a total target filter
If the user has previously forced on a Resynchronization
ghost for this track
  If the track is not within a beta ghosting
qualification region
  Associate the track to the only active CRDA
configuration¹
  End if the track is not within a beta GQR
  Track is to be ghosted - return TRUE ²
End if a resync ghost exists for this track
If the track is not forced on
  If the track is not within an alpha GQR or is not
correlated
    Track is not to be ghosted - return FALSE
  End track not within an alpha or not correlated
End track not forced on
If the track is correlated and within an alpha GQR
  If the track matches the regions qualifiers
    If the track is forced ‘ primary’³
      Mark the track as forced ‘secondary’
    End if the track is forced ‘primary’
    Track is to be ghosted - return TRUE
  End if the track matches the qualifiers
End if the track is correlated and within an alpha GQR
If the track has ghosting forced on
  If the track is not within an alpha GQR
    Associate the track with the only active
configuration
  End if the track is not within an alpha GQR
    Track is to be ghosted - return TRUE
  End if the track has ghosting forced on
  Track is not to be ghosted - return FALSE
```

The main purpose of the DetermineCRDAAction( ) function 106 is set the track's CRDAAction attribute to one of the following values:

```
CRDA_NO_ACTION
CRDA_CREATE_GHOST
CRDA_MOVE_GHOST
CRDA_DELETE_GHOST
  If ghosting is required on this update
    Switch (current track CRDAAction setting)
    Case CRDA_NO_ACTION:
      New track CRDAAction = CRDA_CREATE_GHOST
    Case CRDA_DELETE_GHOST:
      New track CRDAAction = CRDA_CREATE_GHOST
    Default:
      New track CRDAAction = CRDA_MOVE_GHOST
    End switch on CRDA Action
  Else if ghosting is not required for this track
    Switch (current track CRDAAction setting)
    Case CRDA_CREATE_GHOST:
      New track CRDAAction = CRDA_DELETE_GHOST
    Case CRDA_MOVE_GHOST:
      New track CRDAAction = CRDA_DELETE_GHOST
    End switch on CRDA Action
  End if ghosting is not required
```

Once TargetIsToBeGhosted( ) 104 and DetermineCRDAAction( ) 106 are used together to set the track's CRDAAction flag, CRDAProcessing( ) 108 is called for this track. This is the entry point to the heart of the VAST processing.

```
If forced ghosting or resync ghosting has been selected
for this track
  If the configuration that the track was forced for
is no longer active
    Override the track CRDAAction & set to
CRDA_DELETE_GHOST
  End if the configuration associated to this track
is no longer active
End if forced ghosting or resync ghosting has been
selected for this track
TrackSeqList_RemoveTrack( )
Switch (CRDAAction)
Case CRDA_CREATE_GHOST:
  TrackSeqList_InsertTrack( )
  CreateGhostTarget( )
  DetermineInTrailGhostState( )
  DrawGhostTargetBlock( )
Case CRDA_CREATE_RESYNC_GHOST:
  CreateGhostTarget( )
  DrawGhostTargetBlock( )
Case CRDA_MOVE_GHOST:
  TrackSeqList_InsertTrack( )
  EraseGhostTargetBlock( )
  DetermineInTrailGhostState( )
  DrawGhostTargetBlock( )
Case CRDA_DELETE_GHOST:
  EraseGhostTargetBlock( )
  DeleteGhostTarget( )
End switch on CRDA Action
```

A function TrackSeqList_RemoveTrack( ) 110 tries to find the current track in a Track Sequence List 112 and remove it. On CRDA_MOVE_GHOST this track is inserted at a new position, as described below.

A function TrackSeqList_InsertTrack( ) 114 determines the distance of the aircraft from the Target Reference Point (TRP) for the active VAST configuration the track is within, as well as track wake turbulence classification for leading and trailing positions. Wake turbulence classifications are determined using a lookup table AircraftTypeList 116 or a flight plan if current aircraft type is not in the table. The TrackSeqList_InsertTrack( ) function 114 inserts this record into the Track Sequence List 112 at a position ordered by track distance from the TRP. Records in this list are updated every time the CRDA_MOVE_GHOST action is performed. The Track Sequence List 112 is used to determine the In-Trail Ghost Image Reference Point for in-trail ghosts.

All memory required by VAST is allocated dynamically. A CreatGhostTarget( ) function 118 allocates heap for the ghost target structure, initializes all ghost target attributes, and points the reference held within the parent target structure to this ghost record.

A DetermineInTrailGhostState( ) function 120 determines whether or not in trail ghosting is required for the specified parent track. Normally this is just determined by checking the VAST configuration settings related to the alpha Ghosting Qualification Region that the parent track is within. If the In Trail ghost is required and not currently allocated, then the appropriate memory is allocated and all structure elements are initialized. Conversely, if the In Trail ghost is allocated but is no longer required, this function will de-allocate the memory and initialize the In Trail ghost pointer within the ghost structure.

A DrawGhostTarget( ) function 122 controls the drawing of all ghost targets and their data blocks related to an individual track. This includes the tie/stagger/or resync ghost along with the in trail ghost. In addition, any PTL drawing required for a ghost target is also initiated from this function.

An EraseGhostTarget( ) function 124 removes all ghost targets from the plot window related to a single parent track. This includes removal of any PTLs that are being produced for these ghosts. As with the drawing mechanism for normal tracks, this function is often used in conjunction with DrawGhostTarget( ) 122 to move the ghost to a new position on the Plot Window.

A DeleteGhostTarget( ) function 126 removes any PTL associations, de-allocates all memory associated with the ghost targets, and resets all VAST attributes within the parent track structure.

Although the track update mechanism is the key trigger to initiate the VAST processing, there are several other entry points that will cause individual or all track's to be processed by this logic. The other events that can trigger the VAST processing include:
Changing any value in an individual track's flight plan will cause that track to be re-processed against all active Ghosting Qualification Regions
Activation or deactivation of VAST configurations will cause all tracks to be processed immediately against all active GQRs
Activation or deactivation of VAST as a whole (from the QAB) will cause re-processing of all tracks
Selecting ‘Forced Ghost/Resync Ghost’ from the track menu will cause VAST processing to be performed for that specific track
Manually removing a ghost via the ghost track's context menu

The DrawGhostTarget( ) function 122 supports two distinct drawing modes, a quick re-draw mode and a full draw mode. These are identified by CRDA_QUICK-DRAW and CRDA_FULL_DRAW respectively. Typically, the quick draw is used when it is desired to re-draw the ghost track and related data block in the same position as it was last drawn, the full draw mode is used otherwise.

First the symbol for the current ghost is chosen, then for a full draw the following functions are invoked:
GetGhostPosition( ) 130,
DetermineGhostTagContents( ) 132, and
PositionTargetBlockElements( ) 134

GetGhostPosition( ) 130 calculates the new position for the ghost target in question, DetermineGhostTagContents( ) 132 sets up the ghost data block based on the current user selections. Position TargetBlockElements( ) 134 is used to determine where to place the data block and how to attach it to the PPS with leader lines.

While GetGhostPosition( ) 130 and DetermineGhostTagContents( ) 132 are functions built specifically for VAST, PositionTargetBlockElements( ) 134 is the same function that is called for both normal tracks and ghosts. VAST makes use of routines that exist for normal tracks wherever possible. This is done by calling GhostToTrackEntry( ) to convert the ghost structure into a track structure, and then calling the routine that expected a track structure as one of its arguments. When the function returns, the TrackEntryToGhost( ) routine converts the modified track structure back to a ghost structure.

This philosophy was employed to prevent duplicating many functions that already existed for a track, when the same service was required by a ghost. In addition to reducing the need for duplicated code, this method prevents having to continually check within a function to see if we are dealing with a normal track or a ghost track, and prevents all functions from having to understand what comprises a ghost structure. This makes the code more maintainable, as any changes made to a single location affects both the ghost and the normal track.

After calling PositionTargetBlockElements( ) 134, if an In Trail ghost is required it is drawn before completing the rendering of the ghost target itself by calling DrawIn TrailGhostTargetBlock( ) 136.

If we are in the quick draw mode, DrawPTL( ) (not shown in FIG. 5) is called to re-display the PTL for the current ghost. If we are in the full draw mode then LayoutAndDrawPTL( ) 138 is called instead to both recalculated and then draw the related PTL.

Finally the symbol colour is set based on the current type of ghost and whether the tower or terminal colour set is selected, and the ghost is displayed.

The EraseGhostTarget( ) function 124 is specifically written to handle ghost targets. When a target update is processed by PlotUpdate( ) the target must be erased before it is redrawn at the new position. A target block is also erased if it has been dropped, or become stale, as called from DeleteDroppedAndStaleTargets( ).

To erase a ghost target block, the routine calls PaintRectOnPlotWindow( ) to rebuild the area of the Plot Window encompassed by the ghost target block's bounding rectangle.

Before erasing the ghost target block, this routine sets the ‘Exclude’ flag for the target's ghost Track List entry. This will prevent the target block itself from being redrawn when the rectangle for the target block is being built up. Similarly if the target has a PTL then they can also be flagged Excluded from being redrawn. After the erasure has been completed then these exclusions will be removed.

The only special handling of this function that differs from the basic design of the EraseTargetBlock( ) routine is that this function will also remove any In Trail ghost that exist for the same parent track. This is done because all ghost targets related to a single parent are always updated in pairs.

All ghost targets related to the same parent track are updated on the same cycle, therefore the DrawGhostTarget( ) routine calls DrawInTrailGhostTarget( ) 136 whenever there is an In Trail ghost related to the same parent.

Ghost targets make use of the same RecordTrailDot( ) function that is used by normal tracks to create an entry in the trail dot table (refer to the ‘Trail Dot Recording’ section of this document).

Much like the normal tracks, a call to this RecordTrailDot( ) function is made during the PlotUpdate( ) cycle. The added complication with ghost targets is that, for a variety of reasons, the ghost target may actually not be displayed later on in the VAST processing. Therefore we must do some cursory checks to ensure that the trail dot is not created if the ghost will itself later be suppressed from the display.

The conditions that will cause VAST not to display a currently created ghost target are as follows:
Ghost target is suppressed by the current VAST configuration settings,
Ghost targets is manually forced off by the user,
The Ghosting on Demand feature is turned on and there are no qualifying aircraft in the related Beta Ghosting Qualification Region

The number of trail dots displayed for a ghost target will always be equal to the current setting for normal tracks, for simplicity there is no separate option for number of ghost trail dots. It is however possible to independently turn on and off ghost trail dots.

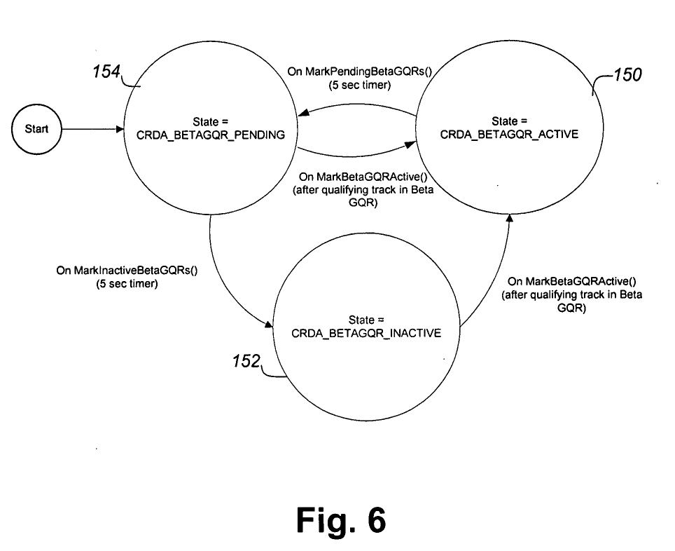

Referring to FIG. 6, there is illustrated in a state diagram possible states for a beta geographic qualification region (Beta GQR) in accordance with an embodiment of the present invention. Special processing is required to provide the functionality required by VAST's Ghosting on Demand feature. This feature, when enabled, causes VAST to automatically enable and disable itself based on the presence of aircraft approaching the beta runway.

This requires the system to understand when qualifying aircraft are within a VAST configuration's beta Ghosting Qualification Region.

To do this, a list of all active Beta GQRs is maintained along with the current state of the region. As shown in FIG. 6, there are three valid Beta GQR states:
CRDA_BETAGQR_ACTIVE 150
CRDA_BETAGQR_INACTIVE 152
CRDA_BETAGQR_PENDING 154

Initially, all Beta GQRs are entered into the BetaGQRList as ‘pending’ 154. Every 5 seconds a function MarkInactiveBetaGQRs( ) takes all regions still in the ‘pending’ state and moves them to the ‘inactive’ state 152. A MarkPendingBetaGQRs( ) function is then called to move any currently ‘active’ regions to the ‘pending’ state 154.

When a track update comes in, and that track is detected to be within a beta GQR, that region is moved from its current state to the ‘active’ state 150.

When VAST needs to project a ghost image for a track on the Alpha Approach, and Ghosting On Demand is enabled, it first checks the state of the related Beta GQR. Only if the region is ‘active’ or ‘pending’ is the ghost target displayed. The ghost image is suppressed if the region is ‘inactive’.

The main algorithms for VAST centre around those related to calculating ghost positions. The following provides a high level overview of the GetGhostPosition( ) function 130 and then go into the details of the VAST algorithms for specific ghost projections.

Although the GetGhostPosition( ) function 130 calculates positions for all types of ghost targets, each individual ghost position calculation is treated separately for clarity.

The GetGhostPosition( ) function 130 first determines what VAST configuration to use for the ghost position calculations. This is the VAST configuration related to the alpha GQR that the parent track is within. Next, this function determines what type of ghost VAST it is calculating a position for (resynchronization ghost vs. tie mode ghost vs. stagger mode ghost vs. in trail ghost) and then calculates the position for this type of ghost (in Plot Window x,y coordinates). This is done taking into consideration mirror ghosting and wake turbulence (smart ghosting) options for the VAST configuration that is being used to produce the ghosts. In addition to calculating the position for ghost targets, this function also calculates the heading of the ghost in question (speed for a ghost target is never calculated, as it is always equal to the speed of the parent aircraft).

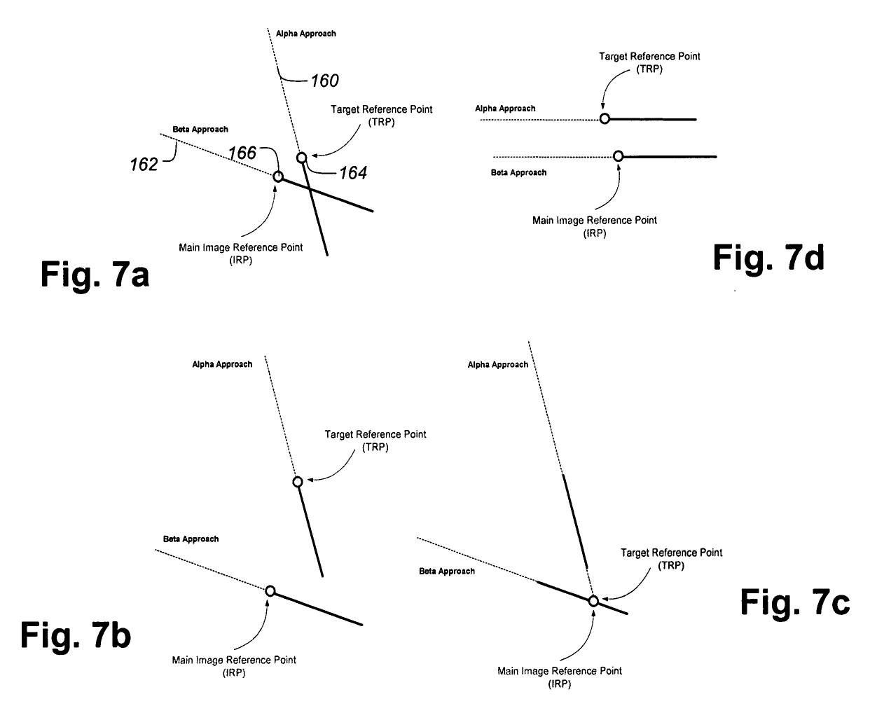

Referring to FIG. 7a, b, c, and d, there are geographically illustrated four examples of runaway configuration with reference points applied in accordance with an embodiment of the present invention.

Before getting into the details of the position calculations for each type of ghost, it is first important to understand how VAST may be applied to an operational environment. For clarity these discussions will be limited to runways, but the same concept applies to other uses of VAST.

Referring to FIG. 7a, the most important parameters of a VAST configuration that are used in ghost position determination include:
1. The magnetic heading of the alpha approach 160
2. The magnetic heading of the beta approach 162
3. The Target Reference Point (TRP) 164
4. The Image Reference Point (IRP) 166

The magnetic heading of the approaches is straight forward, it is the difference between these angles that determines what rotation needs to be applied when calculating the ghost positions.

The starting point for all ghost positions is the position of the parent track. The first step is usually (this depends on the ghost type) to rotate the track position around the Target Reference Point (or TRP) 164 by the difference between the angles of the approaches. The next step is to translate that position by the difference between the TRP 164 and the IRP 166. In other words the parent track is judged against its distance from the TRP 164 and the corresponding rotated ghost is drawn relative to the IRP 166.

If VAST were only applied to intersecting runways, as shown in FIG. 7a, then only a single reference point would be required (the common point, or runway intersection point). Using the TRP/IRP combination does not restrict VAST to intersecting runways. It can be adapted to converging non-intersecting runways (FIGS. 7b and 7c), and to parallel runways (FIG. 7d).

In addition it is possible to adapt VAST in a variety of ways to the same approach configuration. For example, if it is desired to ensure that when one aircraft is at the threshold of its runway, the aircraft on the other approach is back 2 nm from its threshold, then adapting the TRP and IRP to be the thresholds of the runways simplifies the spacing values that must be specified. On the other hand if it is desired to ensure that each successive aircraft to reach the intersection is separated by a certain distance, then adapting the TRP and IRP to be the runway intersection would be more appropriate.

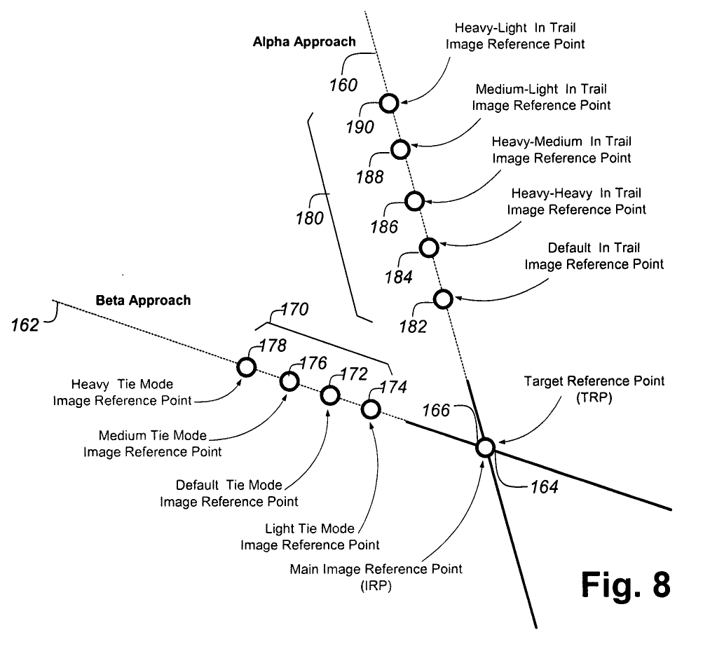

Referring to FIG. 8, there is graphically illustrated an example of reference points for intersecting runway configuration. Ghost images are typically offset from the IRP or TRP by a specified spacing. This spacing value changes dependent on ghost type, mirror ghosting, and wake turbulence considerations. The IRP depicted above (the one specified as part of the VAST configuration) is the main Image Reference Point. To reduce the processing required to compute the ghost positions, a series of image reference points are pre-calculated (using the TRP and IRP specifications and the current spacing values) when a VAST configuration is activated or when spacing values are manually changed by the user.

There are four pre-calculated Image Reference Points 180 used for Tie mode ghosting, and five pre-calculated Image Reference Points used for In Trail Ghosting 180.

The Image Reference Points for Tie Mode Ghosting 170 are Default 172, light 174, medium 176, and heavy 178. The Image Reference Points used for in Trail Ghosting 180 are default 182, Heavy-heavy 184, heavy medium 186, medium light 188, and heavy-light 190. The positions of these points as shown are determined based on the various spacing values comprising an individual CRDA configuration. These relative positions are by no means fixed.

The use of these reference points is further discussed in the following descriptions of ghost position calculations on a type by type basis.

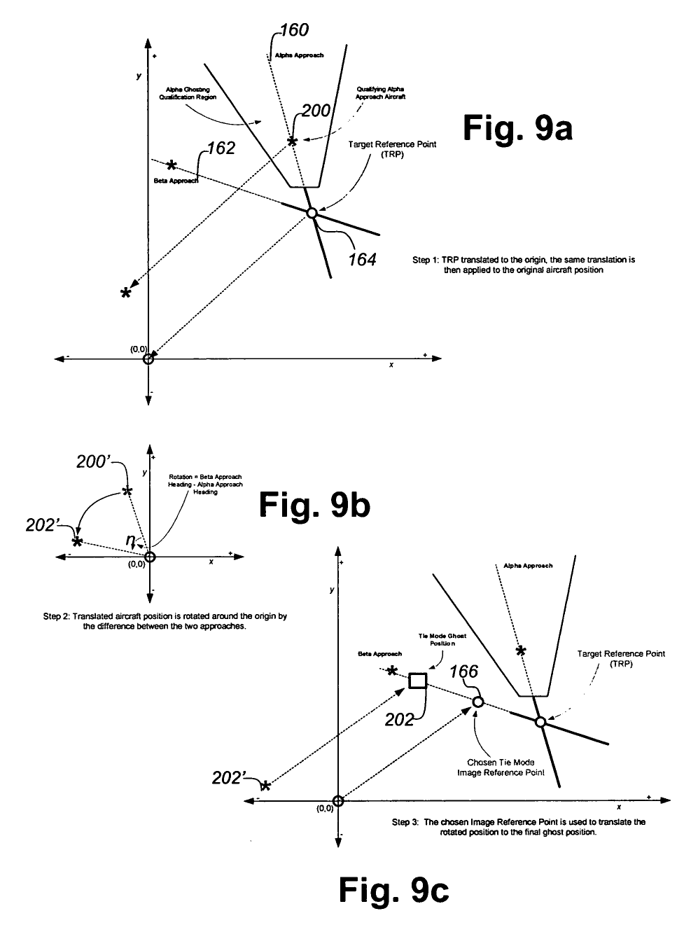

Referring to FIGS. 9a, b, and c, there are graphically illustrated generating a tie mode ghost in accordance with an embodiment of the present invention.

The most common ghost calculation is that of the tie mode ghost. This type of ghost is used as a ‘bulls-eye’ reference point for aircraft on the beta approach 162. When an aircraft on the alpha approach 160 reaches the Target Reference Point 164, the ghost it is producing is offset a specified spacing from the Image Reference Point 166.

For example, as shown in FIG. 9a, assume an airport has intersecting runways, and the TRP 164 and the IRP 166 are defined to be the intersection of those runways. If the tie mode spacing is set to two nautical miles (assume for simplicity that smart ghosting is disabled) then when an aircraft on the alpha runway reaches the intersection of the runways, the ghost for this aircraft is on the beta approach back two nautical miles. If this ghost is used by the controller as a bulls-eye for the beta approach aircraft then successive aircraft to reach the intersection are separated by 2 nm.

To calculate the position for the tie mode ghost, we start with the position 200 of the parent track that is to produce the ghost. This position is rotated around the Target Reference Point 164 n degrees, where n is the difference between the magnetic heading of the two approaches. To do this we translate the whole picture such that the Target Reference is our new origin and use the standard rotation matrix on the translated track position as shown in FIG. 9b. To arrive at the final tie mode ghost position 202 we translate the rotated position by the appropriate Image Reference Point 166 as shown in FIG. 9c.

The chosen Image Reference Point 160 that is applicable for our current ghost calculation is the Default Tie Image Reference Point 172 unless smart ghosting is enabled. If smart ghosting is enabled then the IRP is chosen based on the Wake Turbulence (WT) category of the aircraft producing the ghost.

For stagger mode ghost calculations, the same method as described above is used with the main IRP 166 being used for the final translation rather than an IRP (for stagger mode there is no additional offset, i.e. the distance from the ghost to the main IRP is equal to the distance between the real aircraft and the TRP).

The heading calculation for both the stagger ghost and the tie ghost is the same. There are two formulas used for this calculation, one is used when Mirror Ghosting is enabled, and a different one is used when Mirror Ghosting is not enabled.

```
If Mirror Ghosting is enabled
  Ghost Heading = Beta Approach Angle −
    (Parent Track Heading − Alpha Approach Angle)
else
  Ghost Heading = Beta Approach Angle +
    (Parent Track Heading − Alpha Approach Angle)
```

The In Trail ghost is the simplest of all VAST ghosts. Because the In Trail ghost is not projected from one approach onto another, there is no rotation applied to an In Trail ghost. The Mirror Ghosting and the concept of ‘tie’ and ‘stagger’ mode ghosting are not applicable to the In Trail ghosts.

As shown in FIG. 8, in order to calculate the In Trail ghost position it is necessary to choose an Image Reference Point. Unless Smart Ghosting is enabled, this point will always be the ‘Default In Trail IRP’ 182.

If Smart Ghosting is enabled the Image Reference Points 180 are calculated based on values adapted in the VAST configuration for four combinations of wake turbulence classes, considering leading and trailing aircraft:
Heavy aircraft is followed by heavy aircraft 184,
heavy aircraft is followed by medium aircraft 186,
medium aircraft is followed by light aircraft 188
heavy aircraft is followed by light aircraft 190,

For other combinations of wake turbulence classes or when there is no trailing aircraft the Default In Trail spacing is applied. If aircraft wake turbulence class is undefined the maximum adapted spacing value is always applied (i.e. when heavy aircraft is followed by light aircraft), assuming the worst-case scenario. All described wake turbulence combinations and examples of adapted in-trail spacing values are summarized in the following two Tables.

TABLE A
Minimum In Trail Spacing Values Available in the CRDA
Configuration Panel

| Trailing | Leading Aircraft | | | |
|---|---|---|---|---|
| Aircraft | Heavy | Medium | Light | Unknown |
| Heavy | Heavy/Heavy Stagger | Default Stagger | Default Stagger | Heavy/Heavy Stagger |
| Medium | Heavy/Medium Stagger | Default Stagger | Default Stagger | Heavy/Medium Stagger |
| Light | Heavy/Light Stagger | Medium/Light Stagger | Default Stagger | Heavy/Light Stagger |
| Unknown | Heavy/Light Stagger | Medium/Light Stagger | Default Stagger | Heavy/Light Stragger |

TABLE B
Sample In Trail Spacing Values (in nautical miles)

| | |
|---|---|
| Trailing | Leading Aircraft |

| Aircraft | Heavy | Medium | Light | Unknown |
|---|---|---|---|---|
| Heavy | 3 | 4 | 4 | 3 |
| Medium | 5 | 4 | 4 | 5 |
| Light | 7 | 6 | 4 | 7 |
| Unknown | 7 | 6 | 4 | 7 |

Some aircraft types are considered “special” in a sense that the different wake turbulence classification must be applied depending on whether an aircraft is in leading or in trailing position. “Special” aircraft types with their wake turbulence classes are supplied in the “aircraft.typ” file.

The algorithm that determines an Image Reference Point first consults the Aircraft Types List loaded from the “aircraft.typ” file. If aircraft is not a “special” aircraft then the wake class defined in the flight plan is used. If aircraft wake class is undefined, the worst-case spacing is applied as described above.

Connecting the Target Reference Point and the chosen Image Reference Point forms a vector. It is this vector that is added to the parent aircraft's position in order to determine the position for the In Trail ghost.

The heading for the In Trail ghost does not need to be calculated, as it is always equal to that of the parent aircraft.

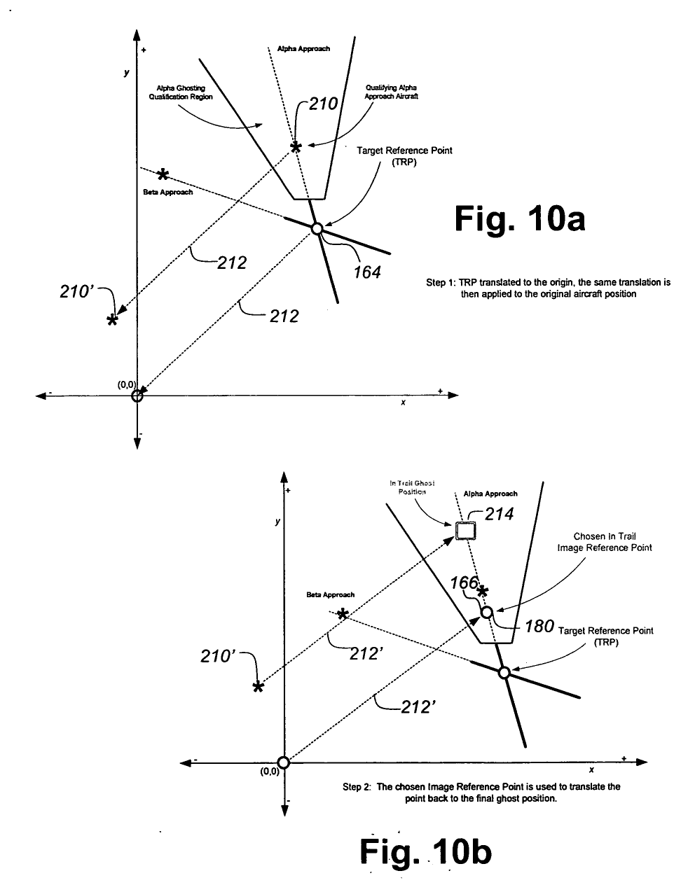

As shown in FIGS. 10a and 10b the target reference point (TRP) 164 is translated to the origin and the aircraft position 210 are translated by the same vector 212 to a position 210′. Next an image reference point 180 is selected, has the origin referenced to the it by a negative vector 212′ as shown in FIG. 10b, the same vector 212′ is then used to translate the position 210′ to form an in trail ghost position 214.

The Smart In Trail Ghost Position calculations make use of the Aircraft Types List, which defines the “special” aircraft types that have a different wake turbulence category when in leading and in trailing position. The Aircraft Types List can only be used if the Smart In Trail Ghosting feature is enabled.

Each record in the Aircraft Types List contains the following fields:
Aircraft type name
Wake turbulence class in leading position
Wake turbulence class in trailing position

The presence of the “aircraft.typ” file is not mandatory for Smart In Trail Ghosting operation. If “aircraft.typ” file is not present, the wake turbulence category specified in the track Flight Plan is used to define the in trail spacing. In this case the wake turbulence category of the aircraft in the leading and trailing position is the same.

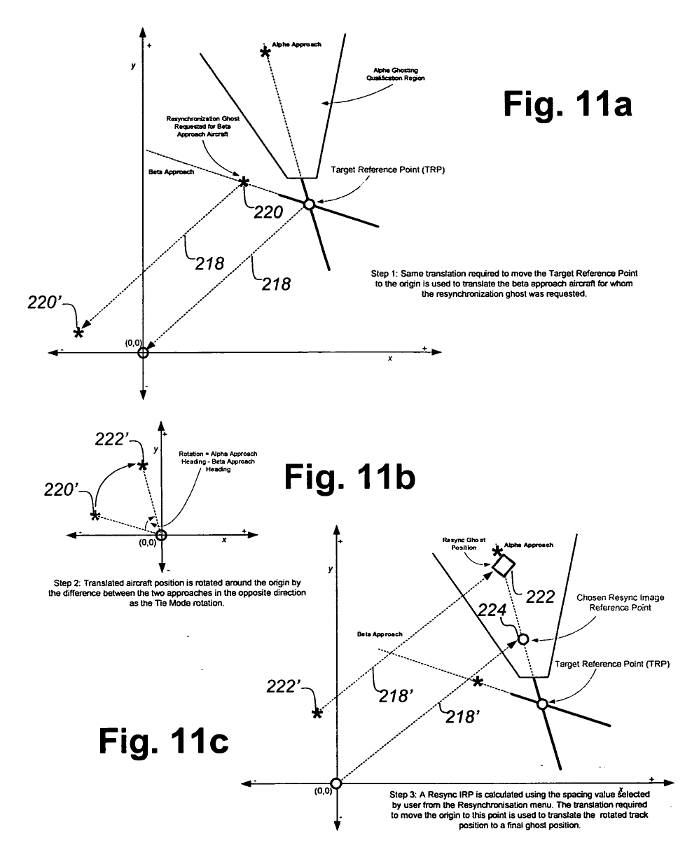

Referring to FIGS. 11a, b, and c, there is graphically illustrated the calculation of the Image Reference Point (IRP) for Resynchronisation ghost. The calculation uses a spacing value selected by the user from a cascade menu of resynchronisation spacing values, which is attached to the track pop-up menu. The projected resynchronisation ghost position is then obtained by rotating the parent track position 220′ from beta onto alpha approach 222′ as shown in FIG. 11b and translating the rotated position back 222 by difference between calculated IRP and main IRP, as shown in FIG. 11c.

After the Image Reference Point 224 is determined, the resync ghost position 222 is calculated in fundamentally the same way that the Tie Mode ghost is determined. The only difference is that the rotation is applied in the reverse direction. There are two formulas used for the calculation of the resync ghost's heading. One is used when Mirror Ghosting is enabled, and a different one is used when Mirror Ghosting is not enabled.

```
If Mirror Ghosting is enabled
  Ghost Heading = Alpha Approach Angle −
    (Parent Track Heading − Beta Approach Angle)
else
  Ghost Heading = Alpha Approach Angle +
    (Parent Track Heading − Beta Approach Angle)
```

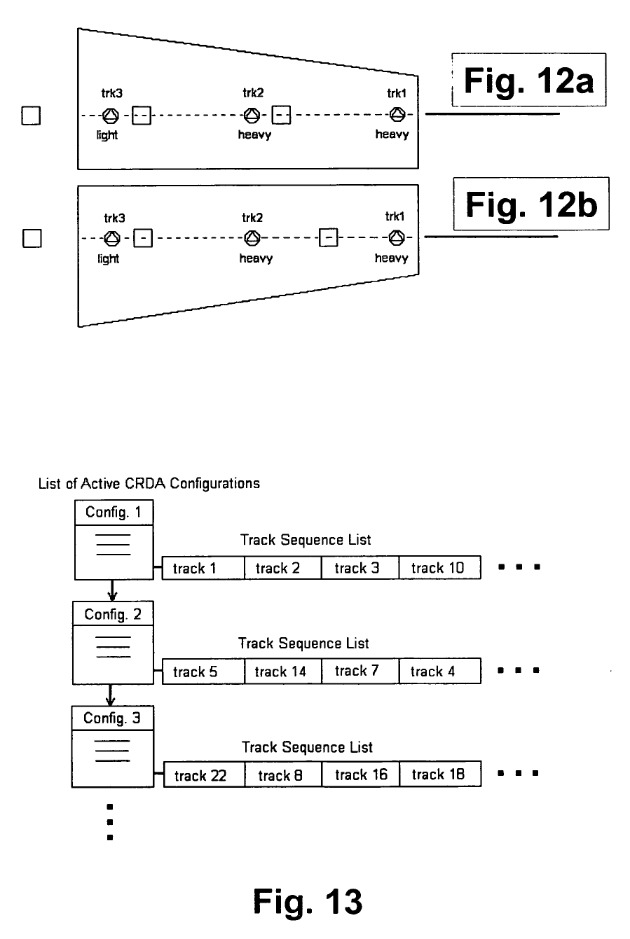

The known ‘Smart In-Trail Ghosting’ feature in the CRDA described with regard to FIG. 4 herein above uses the wake turbulence classification of the leading aircraft only in order to determine the spacing to be used when projecting the In-Trail ghost images for convenience this is shown in FIG. 12a. However, the mix of different aircraft classes and larger percentage of heavy aircraft in various airports, as well as greater demands on these airports creates a need to consider the wake class of both the leading and the trailing aircraft as shown in FIG. 12b. In addition, some aircraft types like B757 and P3 are defined as “special” types which means they are considered “heavy” aircraft in the leading position and “medium” aircraft in the trailing position. Thus for VAST a decision was made to define such aircraft types and their WT classes for leading and trailing position in a separate “aircraft.typ” binary file (Table C). This file is loaded into the AC Type table used for maintenance of the Track Sequence Lists.

TABLE C
Format of the “aircraft.typ” File

| Aircraft type | WT Class | WT Class |
|---|---|---|
| identifier | when leading | when trailing |
| P3 | H | M |
| B757 | H | M |
| . . . | . . . | . . . |
| . . . | . . . | . . . |

WT Class notation: H—“heavy”, M—“medium”, L—“light”.

The Smart In-Trail Ghosting feature that considers the wake turbulence classification of both the leading and trailing aircraft, is implemented using a track sequence list created for each active CRDA configuration. Entries in the track sequence list are ordered according to the track distance from the Target Reference Point defined for that CRDA configuration (ascending order) and contain the following fields:

TABLE D
Track Sequence List Entry

| Field Name | Data Type | Description |
|---|---|---|
| TrackID | unsigned int | Unique track identifier |
| Distance | Double | Track distance from TRP |
| | | (nmi) |
| WTClassLeading | Char | Wake turbulence |
| | | classification for aircraft |
| | | when in leading position |
| WTClassTrailing | Char | Wake turbulence |
| | | classification for aircraft |
| | | when in trailing position |

The following are valid values for the internal wake turbulence classifications of the aircraft (WTClassLeading and WTClassTrailing parameters in the record defined above):
“+” heavy
“/” medium
“−” light
“” (space) unknown

The definition of the VAST configurations has been modified in order to support different combinations of wake classifications of the leading and trailing aircraft as shown herein above in Tables A and B.

A Track Sequence List is maintained as a part of each active VAST configuration.

Before a new track is added to the Track Sequence List, the WT classes (leading and trailing) are checked against the AC Type table based on aircraft type in the Flight Plan. If current aircraft type can not be found in the AC Type table, the WT Class field of the Flight Plan is used. If this field is not defined, the Unknown WT class is used (i.e., “heavy” when leading, “light” when trailing).

The maximum number of tracks to be sequenced is set to 40 per approach (a predefined constant). If the track sequence list is full and the distance of a new qualifying track does not exceed the maximum distance in the track sequence list, then the new track is inserted according to its distance and the farthest track is removed from the track sequence list. If the track sequence list is full and a new qualifying track is the farthest track compared to those in the track sequence list, then the new track is not inserted into the track sequence list.

The default in-trail stagger is applied to the last (i.e. unpaired) track in the sequence list.

The default in-trail stagger is applied to all qualifying tracks not inserted into the track sequence list.

If a new track happens to be at the same distance from Target Reference Point as an existing one, then new track is inserted into the track sequence list after the track with the same distance from Target Reference Point.

Non-correlated tracks are not sequenced.

Image reference points are pre-calculated using adapted values in order to speed-up processing, as described above with reference to FIG. 8.

The user is able to change adapted in-trail spacing values. Image Reference Points are re-calculated accordingly.

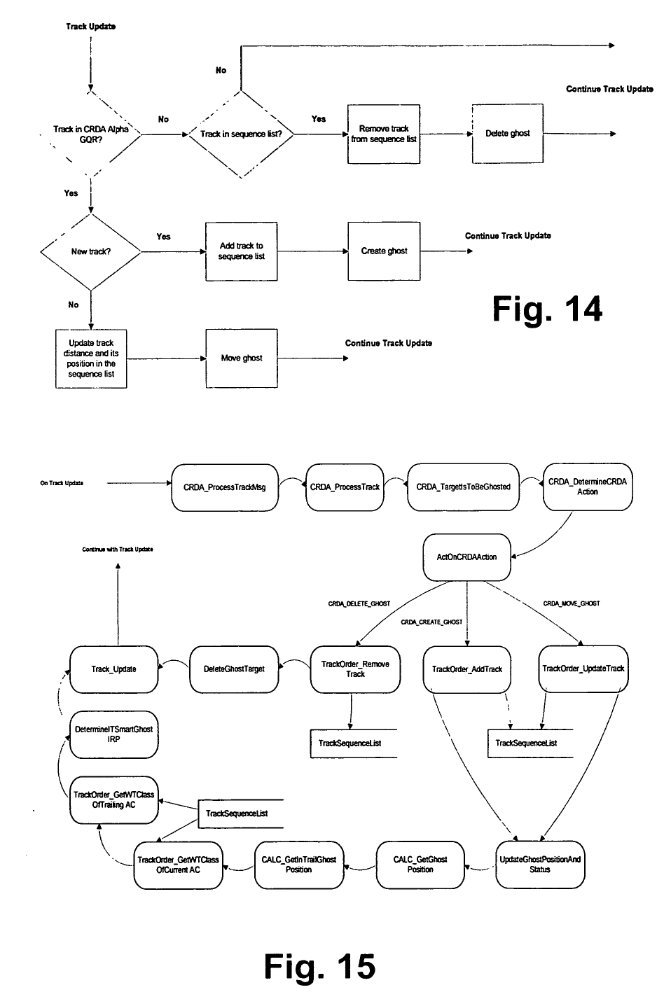

The high-level and detailed data flows of the track update process related to this enhancement are shown in FIG. 14 and FIG. 15 respectively.

The DetermineITSmartGhostIRP( ) routine in selects the proper Image Reference Point based on the WT classes of the current aircraft and the following aircraft sequenced on this approach. The code fragment for the Image Reference Point selection is shown below. For VAST weight constants used in the code refer to Wake Turbulence Classification.

| | |
|---|---|
| static void | |
| DetermineITSmartGhostIRP( | |
| Track *track, | /* parent track related to CRDA track |
| */ | |
| float *Xrb, | /* returned X position of IRP |
| */ | |
| float *Yrb) | /* returned Y position of IRP |
| */ | |
| { | |

CRDA_CONFIGURATION_IRP_STRUCT *pIRPRecord;

| | |
|---|---|
| CRDATrackS *GhostTarget; | |
| char NextWTClass; | /* weight class of the trailing |
| aircraft */ | |
| char CurrentWTClass; | /* Weight class of the current |

```
aircarft */
/*
  * Create a pointer to the correct ghost target structure (the
index of
  * entry within the array of ghost targets is the same as the
index
  * used for the track into the array of track structures.
  */
  GhostTarget = &CRDATracksDb[track->trackId];
  /*
  * Initialization.
  */
  pIRPRecord = &CRDA_ConfigurationIRPRecord[GhostTarget->
  alphaGQR];
  /*
  * Check if there is a Flight Plan for this track.
  */
  if (!track->flags.isCorrelated)
  {
    /*
    * Flight plan does not exist for this track - WT class is
unknown.
    * Log the condition and let the switch statement below deal
with the
    * logic.
    */
    ErrHdl_LogVa( ERRHDL_LOGWARNING,
          “DetermineITSmartGhostIRP”, “Could not determine WT
          class for leading track.”
            “Track ID: %i”, track->trackId);
  }
  /*
  * Determine WT classification code for leading and trailing
aircraft
  * using track sequence list
  */
  CurrentWTClass = TrackOrder_GetWTClassOfCurrentAC(track);
  NextWTClass = TrackOrder_GetWTClassOfTrailingAC(track);
  /*
  * Determine Image Reference Point based on certain combinations
of
  * WT classes of the leading and trailing aircraft
  */
  switch (CurrentWTClass)
  {
  case CRDA_LIGHT_WEIGHT:
    switch(NextWTClass)
    {
  case CRDA_LIGHT_WEIGHT:
  case CRDA_MEDIUM_WEIGHT:
  case CRDA_HEAVY_WEIGHT:
  case CRDA_UNKNOWN_WEIGHT:
  case CRDA_NO_TRAILING_TRACK:
    *Xrb = pIRPRecord->InTrailDefaultIRP.x;
    *Yrb = pIRPRecord->InTrailDefaultIRP.y;
    break;
    default:
      *Xrb = pIRPRecord->InTrailDefaultIRP.x;
      *Yrb = pIRPRecord->InTrailDefaultIRP.y;
    break;
    }
    break;
  case CRDA_MEDIUM_WEIGHT:
switch(NextWTClass)
{
    case CRDA_LIGHT_WEIGHT:
      *Xrb = pIRPRecord->InTrailMediumLightIRP.x;
      *Yrb = pIRPRecord->InTrailMediumLightIRP.y;
      break;
    case CRDA_UNKNOWN_WEIGHT:
      *Xrb = pIRPRecord->InTrailMediumLightIRP.x;
    *Yrb = pIRPRecord->InTrailMediumLightIRP.y;
      break;
    case CRDA_MEDIUM_WEIGHT:
    case CRDA_HEAVY_WEIGHT:
    case CRDA_NO_TRAILING_TRACK:
      *Xrb = pIRPRecord->InTrailDefaultIRP.x;
      *Yrb = pIRPRecord->InTrailDefaultIRP.y;
      break;
default:
      *Xrb = pIRPRecord->InTrailDefaultIRP.x;
      *Yrb = pIRPRecord->InTrailDefaultIRP.y;
      break;
    }
    break;
  case CRDA_HEAVY_WEIGHT:
    switch(NextWTClass)
    {
    case CRDA_LIGHT_WEIGHT:
      *Xrb = pIRPRecord->InTrailHeavyLightIRP.x;
      *Yrb = pIRPRecord->InTrailHeavyLightIRP.y;
      break;
case CRDA_MEDIUM_WEIGHT:
      *Xrb = pIRPRecord->InTrailHeavyMediumIRP.x;
      *Yrb = pIRPRecord->InTrailHeavyMediumIRP.y;
      break;
case CRDA_HEAVY_WEIGHT:
      *Xrb = pIRPRecord->InTrailHeavyHeavyIRP.x;
      *Yrb = pIRPRecord->InTrailHeavyHeavyIRP.y;
      break;
case CRDA_UNKNOWN_WEIGHT:
      *Xrb = pIRPRecord->InTrailHeavyLightIRP.x;
      *Yrb = pIRPRecord->InTrailHeavyLightIRP.y;
      break;
case CRDA_NO_TRAILING_TRACK:
      *Xrb = pIRPRecord->InTrailDefaultIRP.x;
      *Yrb = pIRPRecord->InTrailDefaultIRP.y;
      break;
default:
      *Xrb = pIRPRecord->InTrailDefaultIRP.x;
      *Yrb = pIRPRecord->InTrailDefaultIRP.y;
      break;
    }
    break;
  case CRDA_UNKNOWN_WEIGHT:
    switch(NextWTClass)
    {
    case CRDA_LIGHT_WEIGHT:
      *Xrb = pIRPRecord->InTrailHeavyLightIRP.x;
      *Yrb = pIRPRecord->InTrailHeavyLightIRP.y;
      break;
case CRDA_MEDIUM_WEIGHT:
      *Xrb = pIRPRecord->InTrailHeavyMediumIRP.x;
      *Yrb = pIRPRecord->InTrailHeavyMediumIRP.y;
      break;
case CRDA_HEAVY_WEIGHT:
      *Xrb = pIRPRecord->InTrailHeavyHeavyIRP.x;
      *Yrb = pIRPRecord->InTrailHeavyHeavyIRP.y;
      break;
case CRDA_SPECIAL_WEIGHT:
      *Xrb = pIRPRecord->InTrailHeavyMediumIRP.x;
      *Yrb = pIRPRecord->InTrailHeavyMediumIRP.y;
      break;
case CRDA_UNKNOWN_WEIGHT:
      *Xrb = pIRPRecord->InTrailHeavyLightIRP.x;
      *Yrb = pIRPRecord->InTrailHeavyLightIRP.y;
      break;
case CRDA_NO_TRAILING_TRACK:
      *Xrb = pIRPRecord->InTrailDefaultIRP.x;
      *Yrb = pIRPRecord->InTrailDefaultIRP.y;
      break;
    default:
      *Xrb = pIRPRecord->InTrailDefaultIRP.x;
      *Yrb = pIRPRecord->InTrailDefaultIRP.y;
      break;
    }
    break;
  default:
    *Xrb = pIRPRecord->InTrailDefaultIRP.x;
    *Yrb = pIRPRecord->InTrailDefaultIRP.y;
    break;
  }
```

Currently the CRDA configurations are independent entities and must be activated and deactivated individually. An embodiment of the present invention provides association of the VAST configurations that allow activating/deactivating of a set of VAST configurations grouped logically at the adaptation time.

In order to implement the associative relationship in VAST configurations, an additional data field “AssociatedWithName” has been introduced into the VAST configuration. This field is set to the name of the “parent” VAST configuration at adaptation time. Only one level of association is allowed: each child can have only one parent, parent configurations having at least one child configuration cannot be associated with any other configuration. In the parent VAST configuration the ‘AssociatedWithName’ field must be blank.

Rules for activation and de-activation of associated VAST configurations:
When a parent VAST configuration is activated (deactivated) all associated configurations are activated (deactivated) simultaneously and added to (removed from) the list of active configurations and corresponding map overlays.
Only parent configurations are shown in the drop-down menu of the available VAST configurations under “VAST” button; the user can select and edit individual configurations associated with the parent VAST using the VAST dialog panel.

Rules for re-activation of associated VAST configurations when new configuration file is loaded:
Re-activation of associated VAST configurations is based on the name and type of the parent VAST. If any parent VAST in the new file has the same name and type (Terminal, En-Route) as previously active parent VAST, it will be activated together with all its child VAST configurations, even if some or all of those child configurations are new.
   Note: parent VAST configuration cannot have child configurations of other type because RAHSTA makes it impossible to associate configurations of different types.

If previously active parent configuration is now a child of the new parent, neither the new parent nor the child will be activated.
Settings are preserved only for previously active parent and child configurations. All new child configurations of the previously active parent configuration are activated with the default settings, as adapted.

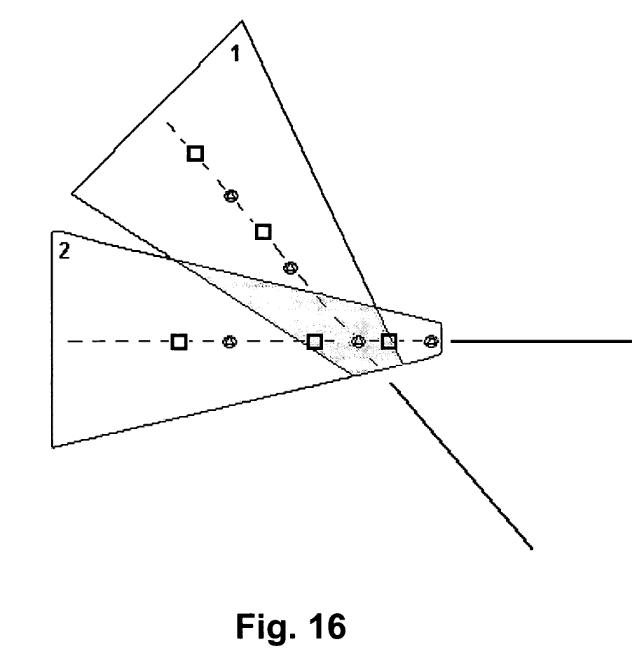

Referring to FIG. 16 there are graphically illustrated two overlapping ghost qualification regions (GQR) as a further embodiment. At any one time an aircraft may qualify for only a single alpha GQR. The alpha GQRs of different VAST configurations are allowed to overlap. However, the track management module allows only a single set of ghosts (a single Stagger or Tie or Resynchronization ghost, along with an In-Trail ghost) to be generated for a single aircraft at any point in time. To do this effectively, the VAST logic preserves the “continuity” of ghosting when an aircraft enters and leaves an overlapping region.

Implementation of overlapping GQR does not require any changes in the VAST configuration structure and RAHSTA. If track is within the multiple GQR, then track qualifiers are checked and the previous region this track has qualified for is set as a region this track is currently associated with.

The code fragment from Crda.c file shown therein below illustrates how the application keeps track of the previous qualification region using global flags that indicate if the region where track is detected can be overridden.

/*-------------------------------------------------------------------
-----------
| Purpose:
| This functions is called when the a track has been detected
within
| a registered CRDA Alpha Ghosting Qualification Region AND
matches
| all qualifiers related to the filter.
---------------------------------------------------------------------
---------*/
static void
qualifyingTrackInAlphaGQR(

| | | |
|---|---|---|
| int | event, | /* pivot event */ |
| Pvt_Pointer | userData, | /* Unused */ |
| Pvt_Pointer | callData ) | /* track and geographical |

```
filter */
  {
  CRDATrackS *GhostTarget;
  GEOFILTER_CALLBACK_STRUCT *data =
(GEOFILTER_CALLBACK_STRUCT *)callData;
  /*
  * Create a pointer to the correct ghost target structure (the
index of
  * the entry within the array of ghost targets is the same as the
index
  * used for the track into the array of track structues.
  */
  GhostTarget = &CRDATracksDb[data->track->trackId];
  /*
  * It is only possible to be within a single alpha GQR
  * at any one point in time.
  */
  if (allowAlphaOverride == RSIT_TRUE)
  {
    /*
    * To preserve continuity, when a track is qualifying for
more than
    * one alpha GQR, we will always use the previous region that
it was
    * qualifying for (if it is still valid).
    */
    if ((GhostTarget->previousAlphaGQR == CRDA_NONE) ||
      ((GhostTarget->previousAlphaGQR != CRDA_NONE) &&
      (GhostTarget->previousAlphaGQR == data->key)))
    {
      allowAlphaOverride = RSIT_FALSE;
    }
    /*
    * Save an index to the master CRDA configuration record
    * related to this alpha Ghosting Qualification Region.
    */
    GhostTarget->alphaGQR = data->key;
    GhostTarget->alphaQualifiersMet = RSIT_TRUE;
  }
}
/*-------------------------------------------------------------------
-----------
| Purpose:
| This functions is called when the a track has been detected
within
| a registered CRDA Beta Ghosting Qualification Region AND
matches
| all qualifiers related to the filter.
---------------------------------------------------------------------
---------*/
static void
qualifyingTrackInBetaGQR(
```

| | | |
|---|---|---|
| int | event, | /* pivot event */ |
| Pvt_Pointer | userData, | /* Unused */ |
| Pvt_Pointer | callData ) | /* track and geographical |

```
filter */
{
  CRDATrackS *GhostTarget;
  GEOFILTER_CALLBACK_STRUCT *data =
(GEOFILTER_CALLBACK_STRUCT *)callData;
  /*
  * Create a pointer to the correct ghost target structure (the
index of
  * the entry within the array of ghost targets is the same as the
index
  * used for the track into the array of track structues.
  */
  GhostTarget = &CRDATracksDb[data->track->trackId];
  if (allowBetaOverride == RSIT_TRUE)
  {
    if ((GhostTarget->previousBetaGQR == CRDA_NONE) ||
      ((GhostTarget->previousBetaGQR != CRDA_NONE) &&
      (GhostTarget->previousBetaGQR == data->key)))
    {
      allowBetaOverride = RSIT_FALSE;
    }
    GhostTarget->betaGQR = data->key;
    GhostTarget->betaQualifiersMet = RSIT_TRUE;
  }
  /*
  * Although the track will not be considered ‘officially’
  * within more than one beta GQR, it is possible for the
  * track to ‘mark active’ any number of beta GQRs that it
  * is within.
  */
  if (data->track->flags.isCorrelated)
  {
      /*
      * Track is within a Beta GOR, is correlated, and
      * matches all defined CRDA qualifiers related to
      * the current beta GQR - mark the region as active.
      * This will cause the ghosting on demand feature
      * to realize that there are tracks on the beta
      * approach.
      */
      GEOFILTER_SetState(CRDA_BetaFilterType, data->key,
GEOFILTER_STATE_ACTIVE);
}
}
/*-------------------------------------------------------------------
-----------
| Purpose:
| This is a message handler for
GEOFILTER_RESET_TRACK message.
---------------------------------------------------------------------
---------*/
static void
resetAllowOverride(void)
{
  allowAlphaOverride = RSIT_TRUE;
  allowBetaOverride = RSIT_TRUE;
}
Note: parameters previousAlphaGQR, previousBetaGQR are initialized to
CRDA_NONE when new track entry is created in the track database;
```

Although the known CRDA allows for multiple configurations to be active at one time, each of these configurations calculates how far the parent track is off the centerline of the Alpha approach and displays ghost at the same distance from the Beta approach centerline. This restriction makes it difficult to use CRDA as an en-route spacing tool.

In accordance with an embodiment of the present invention, an en-route VAST module provides a controller with a pictorial representation of the relative positions of aircraft on divergent airways. For en-route VAST configurations the association mechanism is used for grouping configurations by a particular metering fix. All child configurations inherit the Image Reference Point (IRP) 166 from their parent. This IRP 166 is then used to draw a virtual Beta approach line and collapse ghosts onto it. Although the Target Reference Point (TRP) 164 for configurations within the group may differ, it is desirable that they all have a common TRP because track distance (and, as a result, ghost position) is calculated relative to the corresponding TRP.

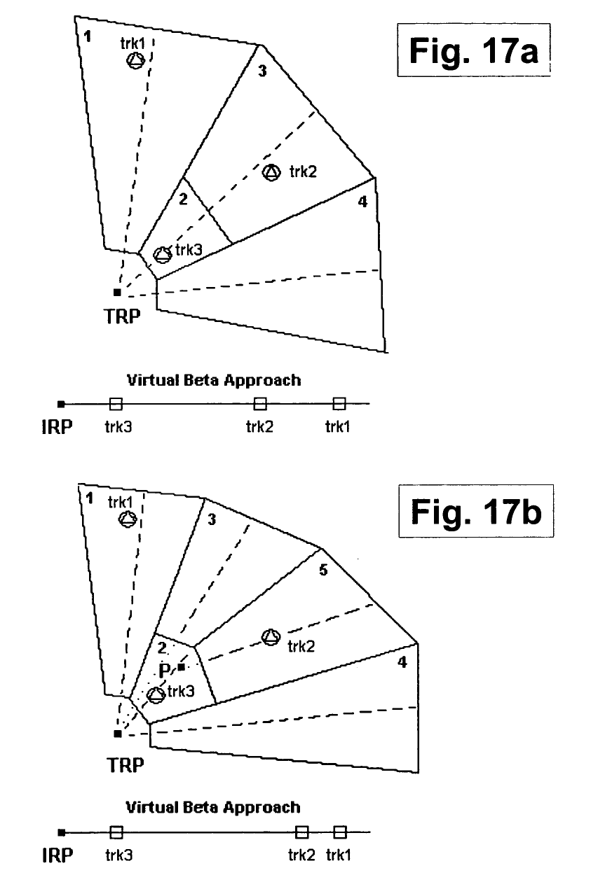

Depending on whether the Alpha approach line leads directly to the fix or not, two types of en-route VAST configurations can be created:
Direct route—any track qualifying for the region produces a ghost at a distance from the MRP being equal to the track distance from the TRP 164 as shown in FIG. 17a.
Indirect route—any track qualifying for the region produces a ghost at a distance from the IRP being equal to the track distance from the TRP plus a distance correction see Trk2 as shown in FIG. 17b. The distance correction is obtained by interpolation of normalized track distance from the Route End Point between the Minimum Track Offset and Maximum Track Offset specified for this configuration see equation (1). Adaptation of indirect en-route CRDA configurations requires the following additional parameters:
   Route End Point latitude and longitude—geographic location where indirect route ends
   Minimum Track Offset (nmi) defines track distance correction at the Route End Point
   Maximum Track Offset (nmi) defines track distance correction at the farthermost point of Alpha GQR relative to the Route End Point
      GhostDistance=D+(MinimumTrackOffset+MaximumTrackOffset*(d/GQRLength)), (equation 1)
      where: GhostDistance—ghost distance from IRP, D—track distance from TRP, d—track distance from Route End Point, GQRLength—maximum length of GQR.

By combining both direct and indirect en-route configurations a user can define a single metering fix for airways of different characteristics and force all ghosts onto one Beta approach.

En-Route VAST configurations contain the “Heading Variance” parameter defining the minimum difference between the track heading and the region alpha approach heading when a heading indicator must be displayed on the projected ghost.

The visibility of the virtual Beta approach line and programmatically generated scale on the Display depends on the “ShowBetaApproach” parameter (YES/NO) of the En-Route VAST configuration. This parameter can be set only at adaptation time.

Implementation details:
Implementation of en-route VAST uses a separate map overlay for virtual Beta approach.
The length of Beta approach line is calculated based on the maximum region size and the maximum value of all adapted offsets for associated indirect routes.
The mileage scale for the virtual Beta approach can be created at run time, depending on the setting of the “ShowBetaApproach” parameter (see above). Scale steps are based on the length of the Beta approach line. If the length is greater than 50 nmi the smaller step is 10 nmi and the larger step is 50 nmi, otherwise the smaller step is 1 nmi and the larger step is 5 nmi.
The ghost position is translated along the Beta approach line according to the calculated track distance. Since there is no ghost rotation involved, the same magnetic variation is applied to all defined IRPs in order to draw all virtual Beta approaches according to their adapted angles despite the distance between IRPs.
Non-correlated tracks are not ghosted.
The ‘Stagger Display Mode’ is enforced at all times.
Ghosts can be forced on non-qualifying tracks through the track menu (as with the terminal VAST configurations).
Mirror Ghosting and Resynchronization Ghosting options are not available for En-Route VAST configurations.
Track sequence lists are not created for En-Route VAST configurations.
A heading indicator is displayed on the projected ghost if the difference between the track heading and the heading specified for the region is more than the Heading Variance. If the Heading Variance has been set to zero at adaptation time, heading indicator is always displayed.

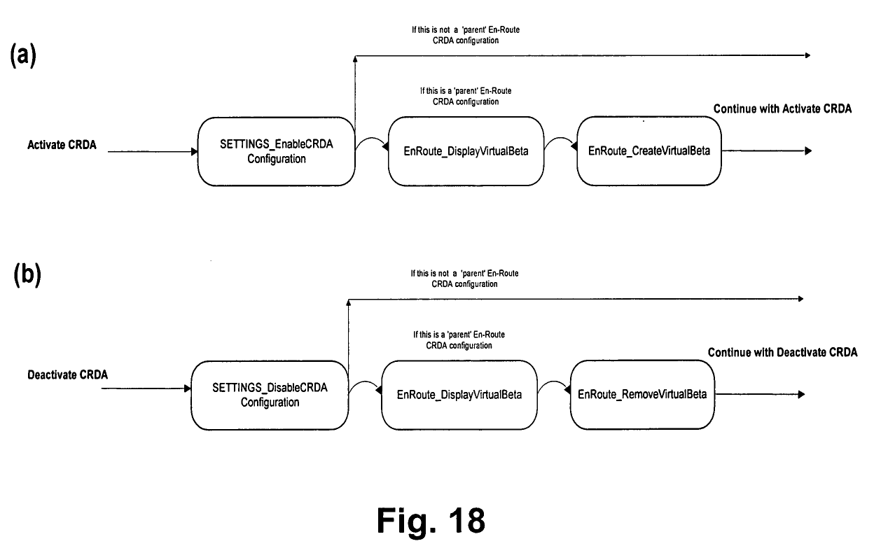

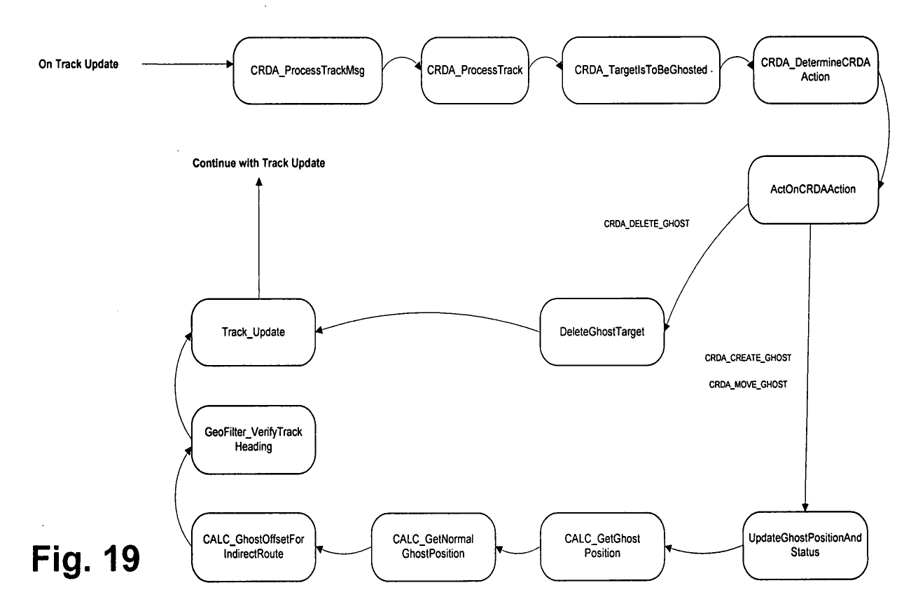

Data flow for En-Route VAST activation and deactivation is shown in FIG. 18. Data flow for track update in En-Route VAST is shown in FIG. 19.

Referring to FIG. 20 there is graphically illustrated an example of a mirror ghosting projection in accordance with an embodiment of the present invention. For simplicity, stagger mode ghosts are shown in a mirror projection. The advantage of the mirror projection is that aircraft can be vectored into the beta approach on a side remote form the alpha approach while simple rotation would result in the ghosts being on a side of the beta approach near the alpha approach.

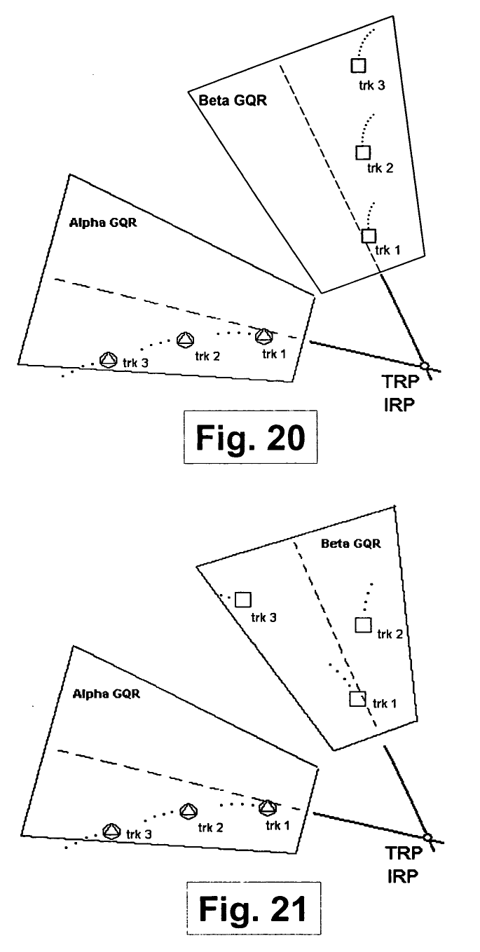

However, in some situations it may be desirable for the controller to be able to turn on/off the mirror ghosting feature on an individual ghost track basis (independently of the current mirror ghost setting for a particular configuration). An example of mirror ghosting on individual track is shown in FIG. 21.

In order to keep track of the mirror ghosting state for individual targets two Boolean flags are introduced into GhostTrackS structure: “allowMirrorGhostingOverride” and “isMirrorGhosted”. The first flag is set to TRUE when a track qualifies for the region and is used to make the mirror ghosting menu option available. If the track qualifies, the second flag is initially set to the current Mirror Ghosting setting of the related VAST configuration. This flag is updated every time the user toggles mirror ghosting on the current ghost track. The mirror ghost position is calculated only if “isMirrorGhosted” flag is set to TRUE. In FIG. 20, stagger mode ghosts are projected for tracks 1 and 3 and a mirror ghost is used for track 2.

Non-correlated tracks cannot be mirror-ghosted.

In order to simplify creation and processing of resynchronization ghosts a range of stagger values for a particular configuration must be specified at adaptation time and used to create a cascade menu on the AT display. This cascade menu is attached to the “Resync Ghost” button of the track menu.

For dynamic menu creation on the AT displays two extra parameters are introduced into the VAST configuration: Resync Min Stagger (nmi) and Resync Max Stagger (nmi). These values are positive integers (0-99) defining the lower and upper bounds for stagger values displayed in the menu. A Step of 1 nmi is used as an increment.

If Resync Min Stagger equals to Resync Max Stagger, a menu is not created and, as a result, the “Resync Ghost” option is not available in the track menu.

User selection of the resync stagger is stored in the “trackResyncSV” field of the CRDATrackS structure.

If the lowest resync stagger is greater than 0, the “0 nmi” button is added to the menu.

For non-correlated tracks Resynchronization Ghosting is not available.

What is claimed is:

1. A method of visual aircraft spacing comprising:
selecting a configuration type from an intersecting runways configuration, a converging runways configuration; a parallel runways configuration; and an en-route configuration;
determining heading for an alpha approach of the selected configuration type;
determining a heading for a beta approach of the selected configuration type;
defining a target reference point in dependence upon the alpha and beta approaches;
determining an image reference point in dependence upon at least one of the target reference point, a difference between the headings, a characteristic of the beta approach and an offset;
selecting a mode of ghosting from tie mode, in-trail mode, and re-synchronizing mode; and
determining a spacing used for separating a ghost image from an aircraft image in dependence upon the mode.

2. A method as claimed in claim 1, wherein the spacing is dependent upon weight classes of both leading and trailing aircraft.

3. A method as claimed in claim 1, further comprising establishing a plurality of configurations.

4. A method as claimed in claim 1, further comprising associating at least two of the plurality of configurations.

5. A method as claimed in claim 1, wherein the associating of at least two of the plurality of configurations includes designating a single configuration as a parent.

6. A method as claimed in claim 5, wherein the spacing is dependent upon weight classes of both leading and trailing aircraft.

7. A method as claimed in claim 1, wherein the selecting of a configuration type selects an en-route configuration.

8. A method as claimed in claim 7, further comprising establishing a plurality of configurations having a particular metering fix.

9. A method as claimed in claim 8, further comprising associating at least two of the plurality of configurations.

10. A method as claimed in claim 9, wherein the associating of at least two of the plurality of configurations includes designating a single configuration as a parent.

11. A method as claimed in claim 7, wherein the alpha approach leads directly to the particular metering fix.

12. A method as claimed in claim 7, wherein the spacing is dependent upon weight classes of both leading and trailing aircraft.

13. A method as claimed in claim 1, wherein the selecting of a mode selects the re-synchronizing mode.

14. A method as claimed in claim 13, wherein the spacing is dependent upon user selection from a predetermined list.

15. A method as claimed in claim 1, further comprising selecting an image projection type.

16. A method as claimed in claim 15, wherein the selecting of an image projection type includes selecting from a normal and a mirror.

17. A method as claimed in claim 16, wherein the selecting of an image projection type selects a mirror.

18. A method as claimed in claim 17, wherein the selecting of an image projection type mirror applies to an entire region.

19. A method as claimed in claim 17, wherein the selecting of an image projection type mirror applies to a track.

20. A method as claimed in claim 17, wherein the spacing is dependent upon weight classes of both leading and trailing aircraft.

21. A visual aircraft spacing tool comprising:
a computer display system;
a parameter for defining a heading for an alpha approach;
a parameter for defining a heading for a beta approach;
a module for defining a target reference point in dependence upon the alpha and beta approaches;
a module for determining an image reference point in dependence upon at least one of the target reference point, a difference between the headings, a characteristic of the beta approach and an offset;
a module for selecting a mode of ghosting from tie mode, in-trail mode, and re-synchronizing mode; and
a module for determining a spacing used for separating a ghost image from an aircraft image in dependence upon the mode.

22. A visual aircraft spacing tool as claimed in claim 21, wherein the spacing is dependent upon weight classes of both leading and trailing aircraft.

23. A visual aircraft spacing tool as claimed in claim 21, further comprising a module for establishing a plurality of configurations.

24. A visual aircraft spacing tool as claimed in claim 21, further comprising a module for associating at least two of the plurality of configurations.

25. A visual aircraft spacing tool as claimed in claim 21, wherein the module for associating at least two of the plurality of configurations includes means for designating a single configuration as a parent.

26. A visual aircraft spacing tool as claimed in claim 25, wherein the spacing is dependent upon weight classes of both leading and trailing aircraft.

27. A visual aircraft spacing tool as claimed in claim 21, wherein the configuration type is an en-route configuration.

28. A visual aircraft spacing tool as claimed in claim 27, further comprising a module for establishing a plurality of configurations having a particular metering fix.

29. A visual aircraft spacing tool as claimed in claim 28, further comprising a module for associating at least two of the plurality of configurations.

30. A visual aircraft spacing tool as claimed in claim 29, wherein the module for associating at least two of the plurality of configurations includes means for designating a single configuration as a parent.

31. A visual aircraft spacing tool as claimed in claim 27, wherein the alpha approach leads directly to the particular metering fix.

32. A visual aircraft spacing tool as claimed in claim 27, wherein the spacing is dependent upon weight classes of both leading and trailing aircraft.

33. A visual aircraft spacing tool as claimed in claim 1, wherein the mode is the re-synchronizing mode.

34. A method as claimed in claim 33, wherein the spacing is dependent upon user selection from a predetermined list.

35. A method as claimed in claim 21, further comprising a module for selecting an image projection type.

36. A method as claimed in claim 35, wherein the image projection type includes a normal and a mirror.

37. A method as claimed in claim 36, wherein the image projection type is a mirror.

38. A method as claimed in claim 37, wherein the image projection type mirror applies to an entire region.

39. A method as claimed in claim 37, wherein the image projection type mirror applies to a track.

40. A method as claimed in claim 37, wherein the spacing is dependent upon weight classes of both leading and trailing aircraft.
